(19) United States
(12) Patent Application Publication
(10) Pub. No.: US 2026/0149969 A1
(43) Pub. Date: May 28, 2026

(54) STATUS FEEDBACK IN 4-WAY HANDSHAKE PROCEDURE

(71) Applicant: Nokia Technologies Oy, Espoo (FI)

(72) Inventors: Orhan Okan MUTGAN, Munich (DE); Jianguo LIU, Shanghai (CN); Zhijie YANG, Shanghai (CN); Gang CHENG, Shanghai (CN); Yiming JIANG, Shanghai (CN)

(21) Appl. No.: 19/123,300

(22) PCT Filed: Oct. 24, 2022
(86) PCT No.: PCT/CN2022/126990

§ 371 Date: Apr. 22, 2025

(51) Int. Cl. H04W 12/06; H04W 76/10

(52) U.S. Cl. CPC H04W 12/06; H04W 76/10

(57) ABSTRACT

Various embodiments provide methods and apparatus for status feedback in a 4-way handshake procedure. In an embodiment, a method performed by a first wireless device comprises: receiving a first message from a second wireless device, the first message comprising identification information of the second wireless device; determining status information at least based on the identification information, the status information indicating a feedback to the first message; and transmitting, to the second wireless device, the status information in a 4-way handshake message in a 4-way handshake procedure between the first wireless device and the second wireless device.

### TECHNICAL FIELD

Embodiments of the present disclosure generally relate to wireless communication, and more particularly, to methods and apparatuses for status feedback in a 4-way handshake procedure.

### BACKGROUND

### Management Frame

Management frames are important components for a Wi-Fi network. As their name suggests, the management frames manage connections between wireless devices (e.g. a wireless station (STA) to/from an access point (AP) or STA to/from STA). The management frames provide certain functionalities such as scanning/discovering, authenticating, associating, roaming, and disconnecting etc. The current 802.11-2020 standard defines 14 different types of management frames including beacon, probe response/request, authentication/deauthentication, association request/response, disassociation, reassociation request/response, and action frames etc.

### Status Code and Reason Code

A management frame body has at least one of two specific fields, namely, Status Code field and Reason Code field as shown in FIG. 1. The Status Code field is used in a response management frame to indicate success or failure of a requested operation. The Reason Code field is used to indicate a reason that an unsolicited notification management frame of type disassociation, deauthentication, and some other frames.

The status code and/or reason code can be inserted into the specific management frame depending on an operation. Currently, 802.11REVme_D1.3 defines 129 status codes (see table 9.78 in 802.11REVme_D1.3) and around 70 reason codes (see table 9.77 in 802.11REVme_D1.3).

As an example, Simultaneous Authentication of Equals (SAE) authentication protocol utilizes authentication frames. Since the authentication frames are management frames, they can use status code/reason code in their frame bodies. In SAE authentication procedure, if the operation experiences some problems, these problems can be indicated by the respective status codes. Table 1 shows some examples of the status codes used in the authentication frames for SAE authentication protocol.

TABLE 1

| Status | | |
|---|---|---|
| code | Name | Meaning |
| 0 | SUCCESS | Successful. |
| 15 | CHALLENGE_FAILURE | Authentication rejected |
| | | because of |
| | | challenge failure. |
| 76 | ANTI_CLOGGING_{—} | Authentication is |
| | TOKEN_REQUIRED | rejected because an |
| | | anti-clogging token |
| | | is required. |
| 123 | UNKNOWN_PASSWORD_{—} | Authentication rejected |
| | IDENTIFIER | because the |
| | | password identifier |
| | | is unknown. |
| 126 | SAE_HASH_{—} | SAE authentication |
| | TO_ELEMENT | uses the hash-to- |
| | | element method |
| | | (#344), instead of |
| | | looping, to |
| | | obtain the PWE. |

As another example, Pairwise Master Key Identifier (PMKID) is used in (re) association frames or Fast Initial Link Setup (FILS) authentication frames. Since association and authentication frames are management frames, they can use status code/reason code field in their frame bodies. Similarly, if the PMKID operation runs into a problem, this problem can be stated by the status/reason code in the association frames. Tables 2 and 3 show some examples of the status codes and reason codes used in association/authentication frames for PMKID.

TABLE 2

| Status | | |
|---|---|---|
| code | Name | Meaning |
| 0 | SUCCESS | Successful. |
| 53 | STATUS_INVALID_PMKID | Invalid pairwise master |
| | | key identifier (PMKID). |

TABLE 3

| Reason | | |
|---|---|---|
| code | Name | Meaning |
| 0 | | Reserved. |
| 49 | REASON_INVALID_PMKID | Invalid pairwise master |
| | | key identifier (PMKID). |

4-way Handshake (HS)

4-way Handshake (HS) is a security association management protocol that was first defined in amendment 802.11i in 2004, then adopted into 802.11 standard. The 4-way HS protocol is using IEEE 802.1X EAPOL-Key frames. The original purpose of the 4-way HS is to establish necessary security keys between the STA and AP. After establishing the security keys in the 4-way HS (i.e., successful completion after generating and verifying the security keys), the STA and AP can start data communication. FIG. 2 shows a diagram illustrating a signaling flow for an association procedure of the STA with AP. The association procedure may include an attach procedure and a 4-way HS procedure. Note that the 4-way Handshake takes place only after a successful attach procedure between the STA and the AP, i.e., after successful authentication and association frame exchanges. Generally, the attach procedure may comprise Probe request/response, Authentication request/response, and Association request/response exchanges. Furthermore, the 4-way HS consists of 4 messages (i.e., Msg1, Msg2, Msg3, Msg4) sent between the STA and AP. Each of these messages carry relevant information depending on the purpose. FIG. 3 illustrates the general frame format for a 4-way Handshake message, i.e., an EAPOL-key frame format.

Furthermore, the original intention of the 4-way HS was to generate/verify security keys for encryption. However, in addition to security key generation/verification, the 4-way HS is becoming a more popular choice to include management operations because part of the frame body of the 4-way HS message can be encrypted, and critical information (such as identifiers (IDs), medium access control (MAC) addresses, relevant parameters, keys) can be carried securely (i.e., encrypted) in the 4-way HS. However, the frame body of most management fames cannot be encrypted, and the critical information are almost always carried unencrypted in probe request/response, authentication request/response, and association request/response.

More specifically, the critical information can be encrypted as something called Key Data Encapsulation (KDE) in the Key Data field in 4-way HS messages, as shown in FIG. 3.

Currently, 802.11REVme_D1.3 defines 15 KDEs as shown in FIG. 4a. Note that some of these KDEs are for security keys (such as group temporal key (GTK), integrity GTK (IGTK), beacon IGTK (BIGTK), wake-up radio IGTK (WIGTK)), some of them are for identifiers (e.g., PMKID, Key ID), some of them are for relevant parameters and information (e.g., Nonce, Error, Operating Channel Information (OCI)), one of them is for MAC address, and some of them are reserved for future use. Some working groups (802.11bh and 802.11be) also propose to add more KDEs relevant to their working direction as shown in FIG. 4b.

From 802.11 standard point of view, the 4-way Handshake messages are considered as data frames, but not management frames, even though they can act like “management frames”. Therefore, the 4-way HS messages do not have status/reason code in their frame body. Lack of status code/reason code in their frame body causes some operations not to establish feedback mechanism.

### SUMMARY

This summary is provided to introduce simplified concepts of status feedback in the 4-way handshake procedure. This summary is not intended to identify key features or essential features of the claimed subject matter, nor is it intended to be used to limit the scope of the claimed subject matter.

According to a first aspect of the disclosure, there is provided a first wireless device. The first wireless device comprises at least one processor and at least one memory storing instructions that, when executed by the at least one processor, cause the first wireless device at least to: receive a first message from a second wireless device, the first message comprising identification information of the second wireless device; determine status information at least based on the identification information, the status information indicating a feedback to the first message; and transmit, to the second wireless device, the status information in a 4-way handshake message in a 4-way handshake procedure between the first wireless device and the second wireless device.

According to a second aspect of the disclosure, there is provided a second wireless device. The second wireless device comprises at least one processor and at least one memory storing instructions that, when executed by the at least one processor, cause the network entity at least to: transmit a first message to a first wireless device, the first message comprising identification information of the second wireless device; receive, from the first wireless device, status information in a 4-way handshake message in a 4-way handshake procedure between the first wireless device and the second wireless device, the status information indicating a feedback to the first message; and determine an operation based on the status information.

According to a third aspect of the disclosure, there is provided a method performed by a first wireless device. The method comprises: receiving a first message from a second wireless device, the first message comprising identification information of the second wireless device; determining status information at least based on the identification information, the status information indicating a feedback to the first message; and transmitting, to the second wireless device, the status information in a 4-way handshake message in a 4-way handshake procedure between the first wireless device and the second wireless device.

According to a fourth aspect of the present disclosure, there is provided a method performed by a second wireless device. The method comprises: transmitting a first message to a first wireless device, the first message comprising identification information of the second wireless device; receiving, from the first wireless device, status information in a 4-way handshake message in a 4-way handshake procedure between the first wireless device and the second wireless device, the status information indicating a feedback to the first message; and determining an operation based on the status information.

According to a fifth aspect of the present disclosure, there is provided a first wireless device. The first wireless device comprises means for performing steps of any method according to the third aspect.

According to a sixth aspect of the present disclosure, there is provided a second wireless device. The second wireless device comprises means for performing steps of any method according to the fourth aspect.

According to a seventh aspect of the present disclosure, it is provided a computer readable medium comprising program instructions that, when executed by an apparatus, cause the apparatus to perform any method according to the third or fourth aspect.

According to an eighth aspect of the present disclosure, it is provided a computer program product comprising program instructions which when executed by at least one processor, cause the at least one processor to perform any method according to the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings in which:

FIG. 1 is a schematic diagram illustrating a management frame;

FIG. 2 is a schematic diagram illustrating a signaling flow of 4-way handshake;

FIG. 3 is a diagram illustrating a frame format for the 4-way handshake messages;

FIG. 4a illustrates KDEs as defined in 802.11REVme_D1.3;

FIG. 4b illustrates KDEs proposed by 802.11bh and 802.11be drafts;

FIG. 5 illustrates a flow of an association procedure for network initiated identification;

FIG. 6 illustrates a flow of an association procedure for STA initiated identification;

FIG. 7 is a schematic diagram illustrating the basic idea of various embodiments of the present disclosure;

FIG. 8a, 8b, 8c illustrates the exemplary frame formats for the 4-way handshake message according to some embodiments of the present disclosure;

FIG. 9 illustrates a signal flow between a first wireless device and a second wireless device according to some embodiments of the present disclosure;

FIG. 10 is a flow chart depicting a method performed by a first wireless device according to some embodiments of the present disclosure.;

FIG. 11 is a flow chart depicting a method performed by a second wireless device according to some embodiments of the present disclosure.;

FIG. 12 illustrates an exemplary process of status feedback in the 4-way handshake procedure for network initiated identification according to some embodiments of the present disclosure;

FIG. 13 illustrates an exemplary process of status feedback in the 4-way handshake procedure for STA initiated identification according to some embodiments of the present disclosure;

FIGS. 14a, 14b and 14c shows three cases illustrating how to use the status information in the 4-way handshake message according to some embodiments of the present disclosure;

FIG. 15 illustrates an exemplary scenario in which some embodiments of the present disclosure can be implemented;

FIG. 16 illustrates an exemplary scenario in which some embodiments of the present disclosure can be implemented;

FIG. 17 illustrates an exemplary scenario in which some embodiments of the present disclosure can be implemented; and

FIG. 18 shows a simplified block diagram of an apparatus according to some embodiments of the present disclosure.

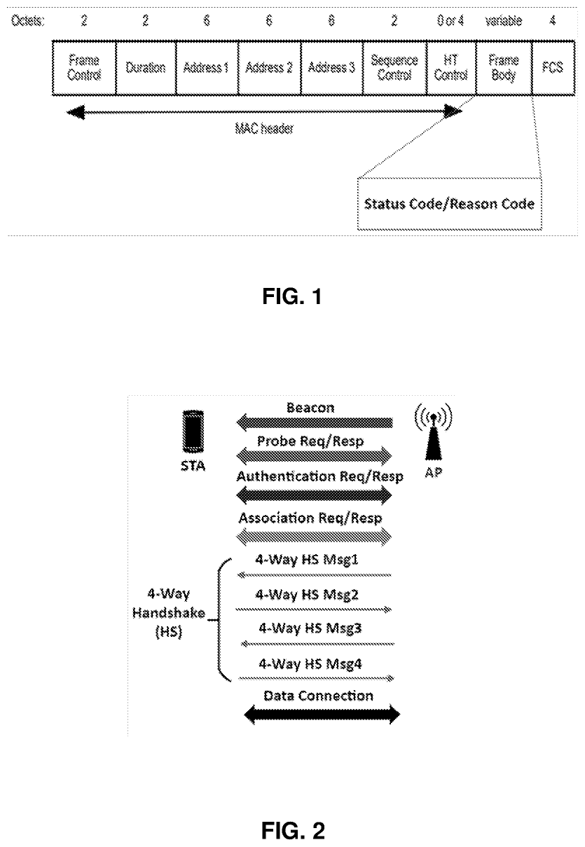

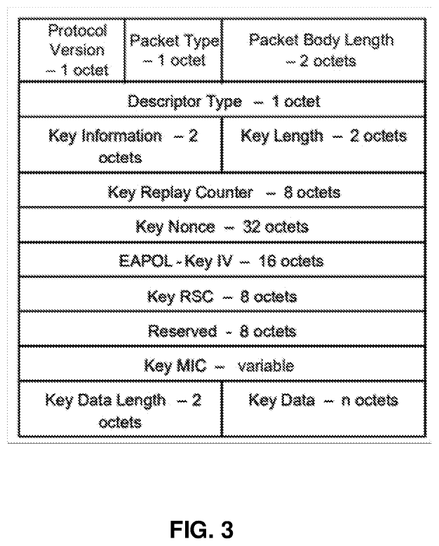

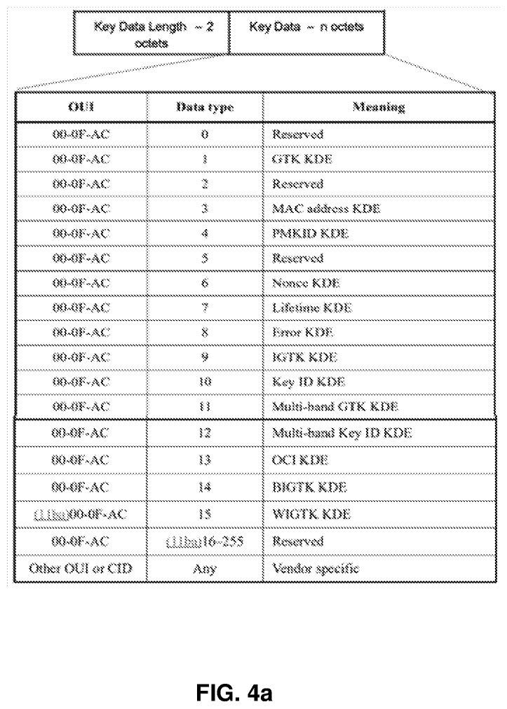

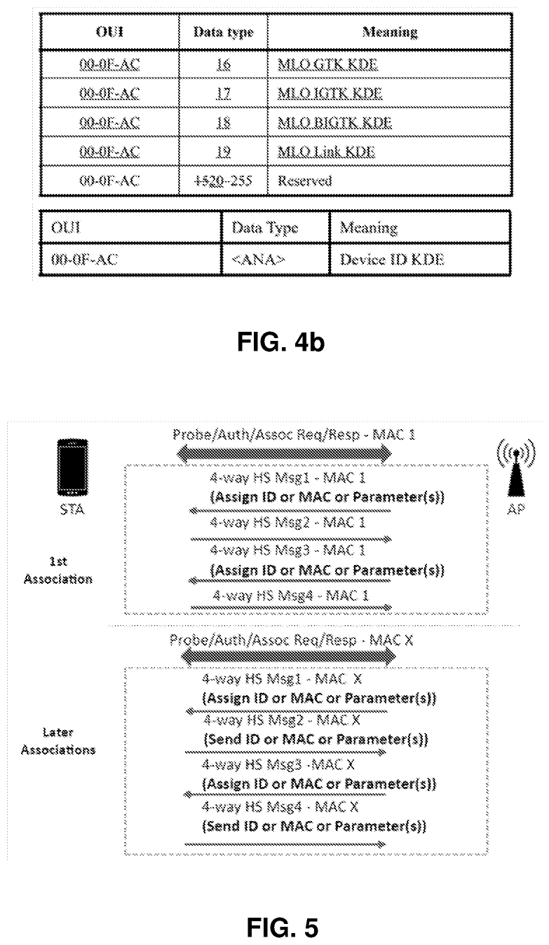

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprise”, “comprising”, “have”, “having”, “include” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of “circuitry” applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

As used herein, the term “wireless network” refers to a Wi-Fi network following any suitable communication standards, such as 802.11 standards. Furthermore, the communications between a supplicant (e.g. a wireless station (STA), or an access point (AP)) and an authenticator (e.g. an access point (AP), or a wireless station (STA)) in the wireless network may be performed according to any suitable Wi-Fi communication protocols. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “wireless device” refers to any device that can wirelessly communicate with another device over a wireless network. By way of example and not limitation, the wireless device may refer to a wireless station, an access point, or other suitable devices. The wireless station may include, but not limited to, a user equipment (UE), an Internet of Things (IoT) device, vehicle-mounted wireless device, etc.

As mentioned above, the 4-way handshake can generate/verify security keys for encryption. Also, 802.11bh group tries to find a mechanism to identify an STA when the STA is using a random MAC address (RMA). The proposed mechanisms in 802.11bh assign an identifier (ID) or MAC address or parameter(s) related to generation of the RMA from/to the STA in the 4-way HS. The identification procedures can be divided into two categories:
Network initiated identification, which covers the cases where:
   the network (e.g. AP) generates and assigns the ID to the STA;
   the network (e.g. AP) generates and assigns the MAC address to the STA; or
   the network (e.g. AP) shares the relevant parameters to the STA so that both sides can generate the same MAC address or ID; and
STA initiated identification, which covers the cases where:
   the STA generates and assigns the ID to the STA;
   the STA generates and assigns the MAC address to the STA; or
   the STA shares the relevant parameters to the AP so that both sides can generate the same MAC address or ID.

The network initiated identification will be described in conjunction with FIG. 5. As shown in FIG. 5, in the first association, the STA follows the normal attach procedure (which includes Probe/Authentication/Association request/response) with the AP and moves into 4-way HS after the attach procedure is successfully completed. During the attach procedure, the STA uses a fixed MAC address, e.g. shown as MAC 1 in FIG. 5. During the 4-way HS, the AP can assign a MAC address or an ID or parameter(s) to the STA in 4-way HS message 1 (Msg1) or 4-way HS message 3 (Msg3). The parameter(s) may include parameters related to generation of the ID and MAC address, or any relevant information. And the STA and AP can complete the 4-way HS. Then the STA and AP may start data connection. After a while, the STA can disconnect from the AP.

Later, the STA wants to associate with the AP again, i.e., a later association. In this case, the STA might use a random MAC address, e.g. shown as MAC X in FIG. 5. This random MAC address may be an identifiable MAC address, i.e., the MAC address assigned to the STA in the previous association or generated by the previously assigned parameter(s), or an unidentifiable MAC address, i.e., the MAC address which was not assigned to the STA in the previous association and is a new MAC address. After the successful attach procedure, the STA moves into 4-way HS, and sends the previously assigned ID or MAC address or parameter(s) in 4-way HS message 2 (Msg2) or 4-way HS message 4 (Msg4). The AP may assign another ID or MAC address or parameter(s) to the STA in 4-way HS Msg1 or 4-way HS Msg3. The STA and AP can complete the 4-way HS and might start the data connection.

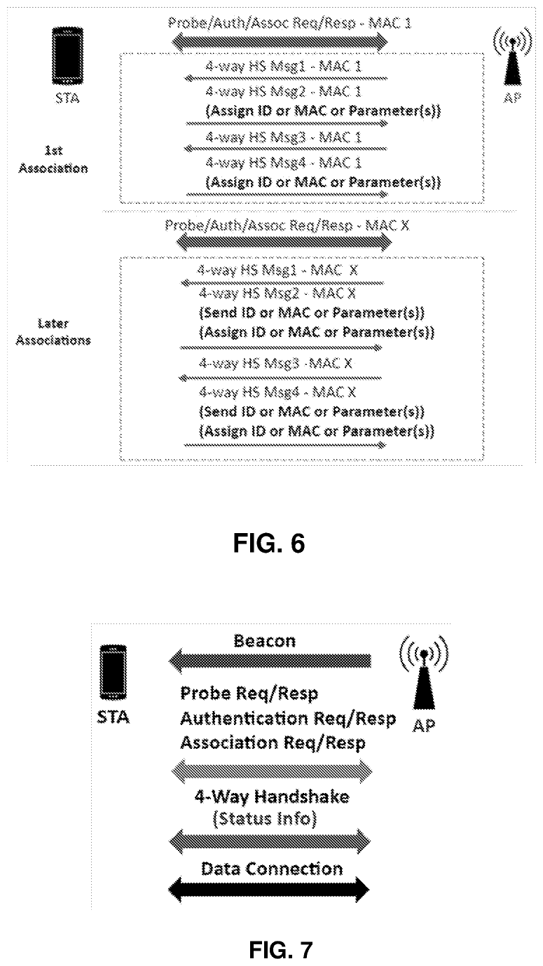

The STA initiated identification will be described in conjunction with FIG. 6. As shown in FIG. 6, in the first association, the STA follows the normal attach procedure (which includes Probe/Authentication/Association request/response) with the AP and moves into 4-way HS after the attach procedure is successfully completed. During the attach procedure, the STA uses a fixed MAC address, e.g. shown as MAC 1 in FIG. 6. During the 4-way HS, the STA can assign a MAC address or an ID or parameter(s) to the STA and notifies the AP in 4-way HS Msg2 or 4-way HS Msg4. The parameter(s) may include parameters related to generation of the ID and MAC address, or any relevant information. And the STA and AP can complete the 4-way HS. Then the STA and AP may start data connection. After a while, the STA can disconnect from the AP.

Later, the STA wants to associate with the AP again, i.e., a later association. In this case, the STA might use a random MAC address, e.g. shown as MAC X in FIG. 6. This random MAC address may be an identifiable MAC address, i.e., the MAC address assigned to the STA in the previous association or generated by the previously assigned parameter(s), or an unidentifiable MAC address, i.e., the MAC address which was not assigned to the STA in the previous association and is a new MAC address. After the successful attach procedure, the STA moves into 4-way HS, and sends the previously assigned ID or MAC address or parameter(s) in 4-way HS message 2 (Msg2) or 4-way HS message 4 (Msg4). The STA may also assign another ID or MAC address or parameter(s) to the STA and notifies the AP in 4-way HS Msg2 or 4-way HS Msg4. The STA and AP can complete the 4-way HS and might start the data connection.

However, there is no feedback mechanism in the 4-way handshake, as the 4-way handshakes are not management frames. If there is no such feedback mechanism, management operations taking place in 4-way HS cannot be fully realized.

For example, if one side (AP or STA) receives the ID, MAC address or relevant parameter(s) from other side (STA or AP) in the 4-way HS and further the received value is unknown/duplicated/invalid, the one side cannot inform the other side. Thus, the other side would not know whether the 4-way handshake procedure is going well. For example, the AP receives an unknown ID from the STA in 4-way HS, if the AP does not inform the STA about the unknown ID, the STA would not know whether the ID it uses is correct or not. Accordingly, the STA would not know whether to resend the ID or send another ID or does not send ID at all.

In addition, the one side might decide to not to continue the 4-way HS and rejects the other side immediately, when it receives the unknown ID or MAC address or relevant parameter(s) in the 4-way handshake. For example, the AP receives an unknown ID from the STA in 4-way HS, and the AP immediately disconnects the STA. But the STA may have another ID to use. If no feedback is sent to the other side, the STA cannot send another available ID, and the 4-way HS procedure stops.

In addition, the one side might not detect an attack. For example, the AP receives a known ID from a STA in 4-way HS, and that STA is actually using or copying a legitimate ID of a legitimate STA. Since the AP does not give feedback to the legitimate STA and accepts the ID from the attacker, the legitimate STA never knows that an attacker is using its ID. If the AP informs the legitimate STA about the ID, the legitimate STA would understand that an attacker is using its ID, because the legitimate STA never sent its ID to the AP.

Thus, it is desirable to enable status information feedback during the 4-way handshake procedure. As mentioned above, many management operations utilize management frames to actualize their operations. An important part of these operations is the status code/reason code field that can be carried in the management frames. The status code/reason code can indicate success/failure/notification of a requested operation. On the other hand, 4-way handshake is becoming more attractive to implement some management operations because 4-way handshake frames can carry critical information (such as identifiers, MAC addresses, parameters, keys) encrypted. However, because the 4-way handshake messages are not management frames, they do not have neither status code nor reason code field in their frame body.

To fully realize management operations taking place in 4-way handshake, various embodiments of the present disclosure describe mechanisms for status feedback in the 4-way handshake procedure, so that the management operations taking place in the 4-way handshake can be fully realized.

The basic idea of the various embodiments of the present disclosure is to add status information in a frame body of a 4-way handshake message to enable management operation in the 4-way handshake procedure. FIG. 7 illustrates the basic idea of the embodiments of the present disclosure. As shown in FIG. 7, the status information can be sent in any of the 4-way handshake messages in the 4-way handshake procedure.

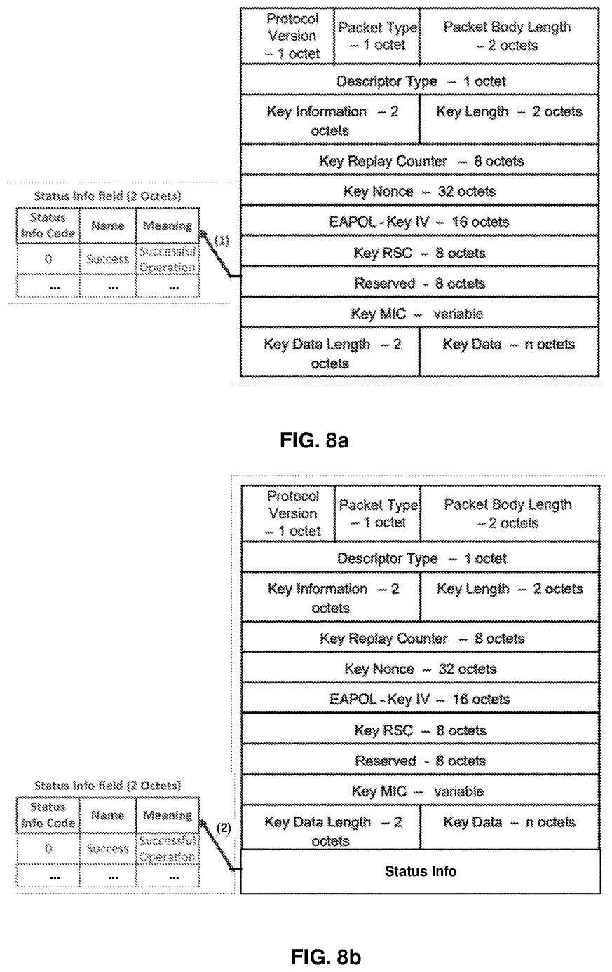

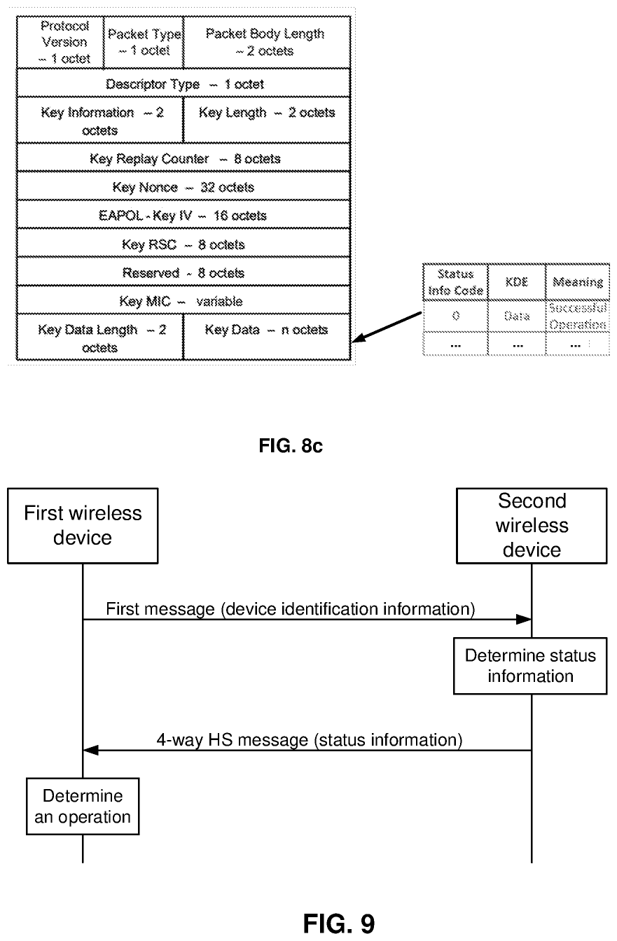

FIGS. 8a, 8b, 8c illustrates the exemplary frame formats for the 4-way handshake message according to some embodiments of the present disclosure. As mentioned above, EAPOL-key frame format is used for the 4-way handshake messages. So, in the embodiments of the present disclosure, the status information may be carried in the frame body of the EAPOL-key frame used as the 4-way handshake message.

In some embodiments, as shown in FIG. 8a, the status information may be carried in a reserved field. In an embodiment, a “status info” field may be defined in the reserved field to carry the status information. In some embodiments, as shown in FIG. 8b, the status information may be carried in a new field, i.e., “status info” field, defined in the EAPOL-key frame. In some embodiments, the status info field may be 2 octets. In some embodiments, as shown in FIG. 8c, the status information may be carried in Key Data field, as a part of 4-way handshake Key Data (KDE). In some embodiments, the status information may be represented by a status info code in the 4-way handshake message. The details about the status information and status info code will be described later.

FIG. 9 illustrates a signal flow between a first wireless device and a second wireless device according to some embodiments of the present disclosure. In some embodiments, the first wireless device may be a supplicant in a wireless network, e.g. a wireless station (STA) or an access point (AP), and the second wireless device may be an authenticator in the wireless network, e.g. an AP or an STA. In some embodiments, the first wireless device may be an authenticator in a wireless network, and the second wireless device may be a supplicant in the wireless network.

As shown in FIG. 9, at step 1, during an association, the first wireless device may send a first message including device identification information of the first wireless device to the second device before or during a 4-way HS. In some embodiments, the device identification information may be but not limited to at least one of a device identifier (simply referred to as “identifier”), an MAC address, relevant parameter(s) to generate the device identifier or MAC address, a GTK, a PMKID, a Nonce, an IGTK, a Key ID and an OCI. In some embodiments, the first message may be carried in a management frame in the attach procedure, or one of the 4-way HS messages in the 4-way HS procedure.

At step 2, upon receiving the device identification information, the second wireless device may determine status information based on the received device identification information and an obtained device identification information which is assigned to the first wireless device during the association or in a previous association. The status information may be used to indicate the receiving status of the first message, or/and an action of a subsequent operation. In some embodiments, the status information may be carried in the 4-way HS message as shown in FIG. 8a or 8b or 8c. In some embodiments, the status information may be represented by a status info code.

At step 3, the second wireless device may transmit the status information to the first wireless device through one of the 4-way handshake messages, which will be described in detail later. At step 4, the first wireless device may determine at least one of the following operations based on the status information:
Continue the 4-way handshake, e.g., if the received device identification information is successfully recognized by the second wireless device;
Re-send the device identification information of the first wireless device, e.g., if the device identification information is timeout;
Send another device identification information of the first wireless device, e.g., if the device identification information is unknown to the second wireless device;
Not send device identification information at all, e.g., if the number of device identification information transmission exceeds a maximum number of times, or the device identification information has been recognized;
Stop the 4-way handshake immediately, e.g., if the device identification information is unknown to the second wireless device.

By defining the status feedback mechanism in the 4-way HS, management operations taking place in the 4-way HS can be fully realized. With the help of the status information, the STA or AP can know whether the operation in the 4-way HS is going well and take actions accordingly, or can decide to continue the 4-way HS or not, or can detect an attack from third parties if they want to manipulate the network.

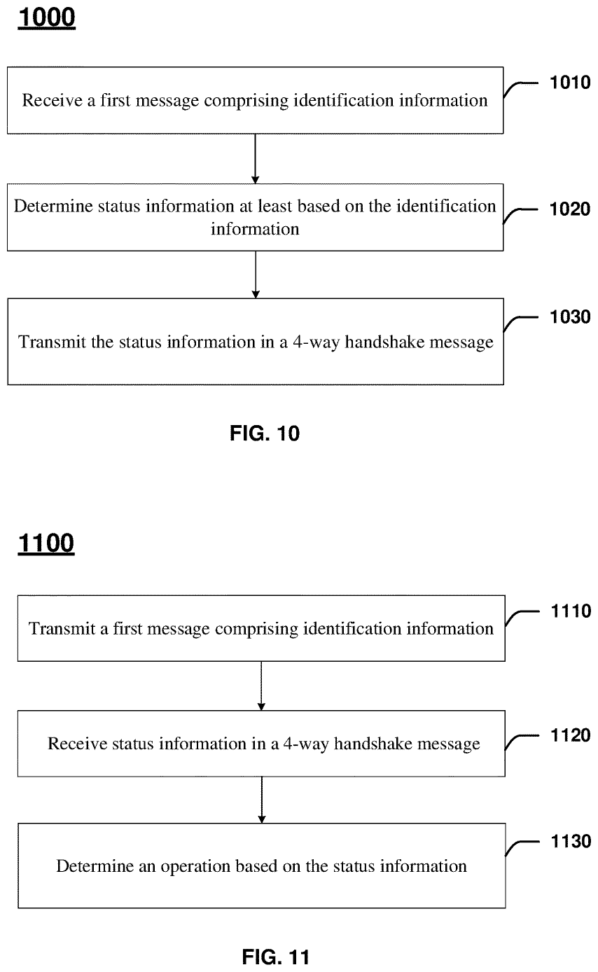

More details of the example embodiments in accordance with the present disclosure will be described with reference to FIG. 10 to FIG. 17.

FIG. 10 is a flow chart depicting a method 1000 performed by a first wireless device according to some embodiments of the present disclosure.

As shown in FIG. 10, the first wireless device receives a first message from a second wireless device at block 1010. The first message may comprise identification information of the second wireless device. In some embodiments, the identification information may comprise at least one of the following: an identifier, a medium access control, MAC, address, or one or more parameters related to generation of the identifier or the MAC address.

In some embodiments, the first message may be one of: a management frame in an attach procedure between the first wireless device and the second wireless device, or a 4-way handshake message in a 4-way handshake procedure between the first wireless device and the second wireless device.

At block 1020, the first wireless device determines status information at least based on the received identification information of the second wireless device. In some embodiments, the status information may indicate a feedback to the first message.

In some embodiments, the first wireless device may compare the received identification information with obtained identification information of the second wireless device. In some embodiments, the obtained identification information may be the identification information assigned to the second wireless device during the current association procedure or a previous association procedure. Then, the first wireless device may determine the status information based on the result of the comparison. For example, if the received identification information matches to the obtained identification information of the second wireless device, it implies that the first wireless device can recognize the received identification information of the second wireless device, and the first wireless can determine the status information that the received identification information is known to the first wireless device. On the other hand, if the received identification information does not match to the obtained identification information of the second wireless device, it implies that the first wireless device cannot recognize the received identification information of the second wireless device, and the first wireless can determine the status information that the received identification information is unknown to the first wireless device.

In some embodiments, the first wireless device may determine whether the received identification information is out of date, e.g. timeout. Then, in response to the received identification information is out of date, the first wireless device may determine the corresponding status information.

In some embodiments, the first wireless device may determine whether the received identification information is duplicated, i.e., whether the received identification information is used by another wireless device. Then, in response to the received identification information is duplicated, the first wireless device may determine the corresponding status information.

In some embodiments, the status information may indicate at least one of the following: success of an operation related to the first message, failure of the operation related to the first message, the received identification information is known to the first wireless device, the received identification information is unknown to the first wireless device, the received identification information is duplicated, or the identification information of the second wireless device needs to be re-sent.

In some embodiments, the status information may be represented by the status info code, as shown in Table 4.

TABLE 4

| Status | | |
|---|---|---|
| info | | |
| code | Name | Meaning |
| 0 | SUCCESS | Successful |
| 1 | REFUSED | Unspecified failure |
| 2 | KNOWN_ID | The ID is known |
| 3 | KNOWN_MAC | The MAC is known |
| 4 | KNOWN_PARAMETER | The parameter(s) |
| | | is known |
| 5 | UNKNOWN_ID | The ID is unknown |
| 6 | UNKNOWN_MAC | The MAC is unknown |
| 7 | UNKNOWN_PARAMETER | The parameter(s) |
| | | is unknown |
| 8 | DUPLICATED_ID | The ID is a duplicated |
| | | ID (ID is used by |
| | | another wireless device) |
| 9 | DUPLICATED_MAC | The MAC is a duplicated |
| | | MAC (MAC is |
| | | used by another |
| | | wireless device) |
| 10 | DUPLICATED_{—} | The parameter(s) |
| | PARAMETER | is a duplicated |
| | | parameter(s) (parameter(s) |
| | | is used by |
| | | another wireless device) |
| 11 | RESEND_ID | Needs to re-send ID |
| 12 | RESEND_MAC | Needs to re-send MAC |
| 13 | RESEND_PARAMETER | Needs to re-send |
| | | parameter(s) |
| Reserved | OTHER | Vendor specific |

At block 1030, the first wireless device transmits to the second wireless device the status information in a 4-way handshake message in the 4-way handshake procedure. In some embodiments, the status information may be carried in a Reserved field of the 4-way handshake message, e.g. as shown in FIG. 8a. Alternatively, in some embodiments, the status information may be carried in a new field of the 4-way handshake message, e.g. as shown in FIG. 8b. Alternatively, the status information may be carried in a Key Data field of the 4-way handshake message, e.g. as shown in FIG. 8c.

In some embodiments, the status information may be transmitted in at least one of a 4-way handshake message 1 (Msg1), a 4-way handshake message 2 (Msg2), a 4-way handshake message 3 (Msg3), and a 4-way handshake message 4 (Msg4) in the 4-way handshake procedure.

In some embodiments, the first wireless device may be an authenticator in a wireless network, and the second wireless device may be a supplicant in the wireless network. Thus, in some embodiments, the first message may be any management frame in the attach procedure between the first wireless device and the second wireless device. In this case, the status information is transmitted in the 4-way handshake Msg1 in the 4-way handshake procedure.

Alternatively or additionally, in some embodiments, the first message may be the 4-way handshake Msg2 in the 4-way handshake procedure. In this case, the status information is transmitted in the 4-way handshake Msg3.

In some embodiments, the first wireless device may be a supplicant in a wireless network, and the second wireless device may be an authenticator in the wireless network. Thus, in some embodiments, the first message may be the 4-way handshake Msg1 in the 4-way handshake procedure. In this case, the status information is transmitted in the 4-way handshake Msg2.

Alternatively or additionally, in some embodiments, the first message may be the 4-way handshake Msg3 in the 4-way handshake procedure. In this case, the status information is transmitted in the 4-way handshake Msg4.

In some embodiments, the supplicant may be a wireless station (STA), and the authenticator may be an access point (AP). Alternatively, the supplicant may be a first STA, and the authenticator may be a second STA. Alternatively, the supplicant may be a first AP, and the authenticator may be a second AP.

FIG. 11 is a flow chart depicting a method 1100 performed by the second wireless device according to some embodiments of the present disclosure.

As shown in FIG. 11, the second wireless device transmits the first message to the first wireless device, at block 1110. The first message may comprise the identification information of the second wireless device. As described above, the identification information may comprise at least one of the following: the identifier, the medium access control, MAC, address, or one or more parameters related to generation of the identifier or the MAC address. The first message may be one of: the management frame in the attach procedure, or a 4-way handshake message in the 4-way handshake procedure.

At block 1120, the second wireless device receives from the first wireless device status information in a 4-way handshake message in the 4-way handshake procedure. As described above, the status information may indicate the feedback to the first message. In some embodiments, the status information may indicate at least one of the following: success of an operation related to the first message, failure of the operation related to the first message, the received identification information is known to the first wireless device, the received identification information is unknown to the first wireless device, the received identification information is duplicated, or the identification information of the second wireless device needs to be re-sent. The status information may be represented by the status info code as defined in Table 4 above.

In some embodiments, the status information may be received in a Reserved field of the 4-way handshake message, e.g. as shown in FIG. 8a. Alternatively, in some embodiments, the status information may be received in a new field of the 4-way handshake message, e.g. as shown in FIG. 8b. Alternatively, the status information may be received in a Key Data field of the 4-way handshake message, e.g. as shown in FIG. 8c.

In some embodiments, the status information may be received in at least one of the 4-way handshake Msg1, the 4-way handshake Msg2, the 4-way handshake Msg3, and the 4-way handshake Msg4 in the 4-way handshake procedure.

In some embodiments, the first wireless device may be an authenticator in a wireless network, and the second wireless device may be a supplicant in the wireless network. Thus, in some embodiments, the first message may be any management frame in the attach procedure, and the status information may be received in the 4-way handshake Msg1 in the 4-way handshake procedure. Alternatively or additionally, in some embodiments, the first message may be the 4-way handshake Msg2 in the 4-way handshake procedure, and the status information may be received in the 4-way handshake Msg3.

In some embodiments, the first wireless device may be a supplicant in a wireless network, and the second wireless device may be an authenticator in the wireless network. Thus, in some embodiments, the first message may be the 4-way handshake Msg1 in the 4-way handshake procedure, and the status information may be received in the 4-way handshake Msg2. Alternatively or additionally, in some embodiments, the first message may be the 4-way handshake Msg3 in the 4-way handshake procedure, and the status information may be received in the 4-way handshake Msg4.

At block 1130, the second wireless device determines an operation based on the status information. In some embodiments, the operation may comprise at least one of the following:
continuing the 4-way handshake procedure;
resending the identification information of the second wireless device;
sending different identification information of the second wireless device;
not sending the identification information of the second wireless device; or
stopping the 4-way handshake procedure.

In some embodiments, at least one management operation can proceed in the 4-way handshake procedure according to the status info code as listed in Table 4. For example, if the status info code is 2, 3, or 4 in 4-way HS Msg3, it implies that the ID or MAC address or parameter(s) sent in 4-way HS Msg2 is known, the operation related to 4-way HS Msg 2 is succeeded and the second wireless device may move on to the next step (e.g. allowing to send 4-way HS Msg4, or completion of the 4-way HS procedure). If the status info code is 5,6, or 7 in 4-way HS Msg3, it implies that the ID or MAC address or parameter(s) sent in 4-way HS Msg2 is unknown, the operation related to 4-way HS Msg2 is failed and the second wireless device may not move on to the next step (e.g. allowing to send 4-way HS Msg4, or completion of the 4-way HS procedure). If the status info code is 8, 9, or 10 in 4-way HS Msg3, it implies that the ID or MAC address or parameter(s) sent in 4-way HS Msg2 is duplicated (i.e., used by another wireless device), the operation related to 4-way HS Msg2 is failed and the second wireless device may not move on to the next step (e.g. allowing to send 4-way HS Msg4, or completion of the 4-way HS procedure). If the status info code is 11, 12, or 13 in 4-way HS Msg3, it implies that the ID or MAC address or parameter(s) sent in 4-way HS Msg2 is unknown or duplicated, but the second wireless device may need to re-send another ID or MAC address or parameter(s) if the second wireless device has one (e.g. if the second wireless device has multiple IDs or MAC addresses or parameters assigned in the previous association procedure). The status info code may be 1, implying that the operation related to the first message is failed (refused) because of an unspecified failure. The status info code may also be 0, implying that the operation related to the first message is succeeded without further specific explanation. Similarly, the status info code may be any vendor specific definition.

In some embodiments, the supplicant may be a wireless station (STA), and the authenticator may be an access point (AP). Alternatively, the supplicant may be a first STA, and the authenticator may be a second STA. Alternatively, the supplicant may be a first AP, and the authenticator may be a second AP.

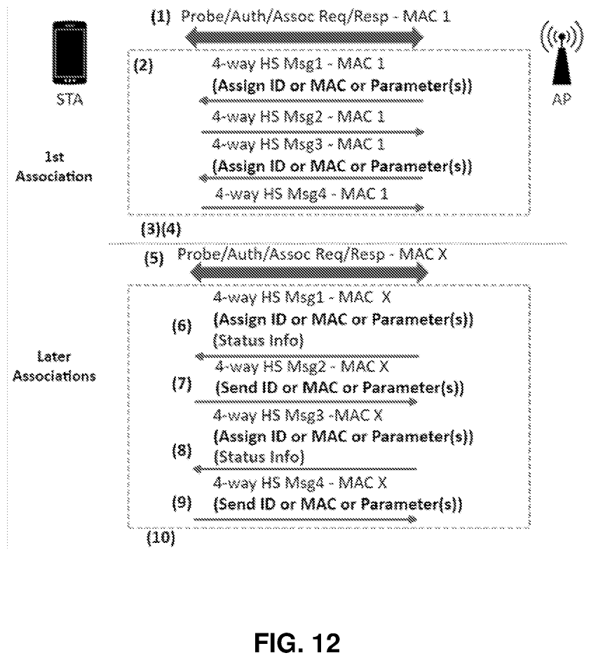

FIG. 12 illustrates an exemplary process of status feedback in the 4-way handshake procedure for network initiated identification according to some embodiments of the present disclosure. In this example, the first wireless device is the authenticator, e.g. the AP, and the second wireless device is the supplicant, e.g. the STA.

As shown in FIG. 12, in the first association procedure, the STA follows the normal attach procedure (Probe/Authentication/Association request/response) (at (1)) and moves into 4-way HS (at (2)) after the successful attach procedure. During this attach procedure, the STA uses a fixed MAC address, MAC 1 as shown in FIG. 12. During the 4-way HS, the AP can assign a MAC address or an ID or parameter(s) to the STA in 4-way HS Msg1 or/and 4-way HS Msg3. The parameter(s) may include one or more parameters to generate the ID, MAC address, or any relevant information. Then the STA and AP can complete the 4-way HS procedure at (3). After that, the STA and AP might start data connection at (4). After a while, the STA may disconnect with the AP.

In the later association procedure(s), the STA wants to associate with the AP again. At this point, the STA might use a random MAC address, MAC X as shown in FIG. 12. This random MAC address may be an identifiable MAC address (i.e., the MAC address assigned to the STA in the previous association procedure or generated by the previously assigned parameter(s)) or an unidentifiable MAC address (i.e., the MAC address which was not assigned to the STA in the previous association procedure and is a new MAC address), at (5). After the successful attach procedure, the STA moves into 4-way HS. The AP may send relevant status information to the STA in 4-way HS Msg1 at (6). Based on the status information, the STA may continue or stop the 4-Way HS, or re-send the ID or MAC address or parameter(s), or send another ID or MAC address or parameter(s), or not send the ID or MAC address or parameter(s). As an example, if the status information indicates “KNOWN_MAC”, the STA will continue the 4-way HS procedure. If the status information indicates “RESEND_ID”, the STA will resend the ID. Also, the AP may assign another ID or MAC address or parameter(s) to the STA in 4-way HS Msg1.

Further, the STA may send the previously assigned (from the previous association procedure) ID or MAC address or parameter(s) in 4-way HS Msg2 at (7), and the AP may send the relevant status information to the STA in 4-way HS Msg3 at (8). Based on the status information, the STA may continue or stop the 4-Way HS, or re-send the ID or MAC address or parameter(s), or send another ID or MAC address or parameter(s), or not send the ID or MAC address or parameter(s). As an example, if the status information indicates “KNOWN_MAC”, the STA will continue the 4-way HS procedure. If the status information indicates “RESEND_ID”, the STA will resend the ID. Also, the AP may assign another ID or MAC address or parameter(s) to the STA in 4-way HS Msg3. The STA may send the previously assigned ID or MAC address or parameter(s) in 4-way HS Msg4 at (9), and the STA and AP complete the 4-way HS and might start the data connection at (10).

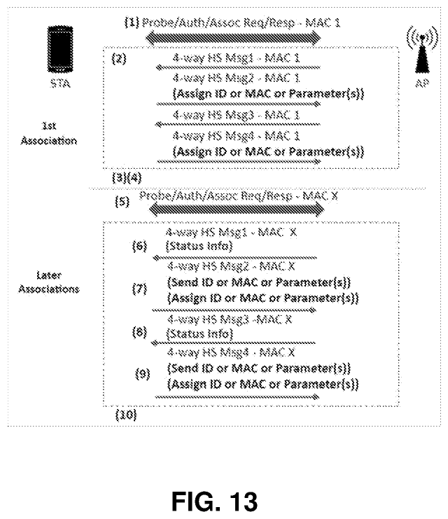

FIG. 13 illustrates an exemplary process of status feedback in the 4-way handshake procedure for STA initiated identification according to some embodiments of the present disclosure. In this example, the first wireless device is the authenticator, e.g. the AP, and the second wireless device is the supplicant, e.g. the STA.

As shown in FIG. 13, in the first association procedure, the STA follows the normal attach procedure (Probe/Authentication/Association request/response) at (1) and moves into 4-way HS (at (2)) after the successful attach procedure. During this attach procedure, the STA uses a fixed MAC address, MAC 1 as shown in FIG. 13. During the 4-way HS, the STA can assign a MAC address or an ID or parameter(s) to the STA and notifies the AP in 4-way HS Msg2 or/and 4-way HS Msg4. The parameter(s) may include one or more parameters to generate the ID, MAC address, or any relevant information. Then the STA and AP can complete the 4-way HS procedure at (3). After that, the STA and AP might start data connection at (4). After a while, the STA may disconnect with the AP.

In the later association procedure(s), the STA wants to associate with the AP again, at (5). At this point, the STA might use a random MAC address, MAC X as shown in FIG. 13. This random MAC address may be an identifiable MAC address (i.e., the MAC address assigned to the STA in the previous association procedure or generated by the previously assigned parameter(s)) or an unidentifiable MAC address (i.e., the MAC address which was not assigned to the STA in the previous association procedure and is a new MAC address). After the successful attach procedure, the STA moves into 4-way HS. The AP may send relevant status information to the STA in 4-way HS Msg1, at (6). Based on the status information, the STA may continue or stop the 4-Way HS, or re-send the ID or MAC address or parameter(s), or send another ID or MAC address or parameter(s), or not send the ID or MAC address or parameter(s). As an example, if the status information indicates “KNOWN_MAC”, the STA will continue the 4-way HS procedure. If the status information indicates “RESEND_ID”, the STA will resend the ID.

Further, the STA may send the previously assigned (from the previous association procedure) ID or MAC address or parameter(s) in 4-way HS Msg2, at (7). Also, the STA may assign another ID or MAC address or parameter(s) to the STA and notifies the AP in 4-way HS Msg2. The AP may send the relevant status information to the STA in 4-way HS Msg3, at (8). Based on the status information, the STA may continue or stop the 4-Way HS, or re-send the ID or MAC address or parameter(s), or send another ID or MAC address or parameter(s), or not send the ID or MAC address or parameter(s). As an example, if the status information indicates “KNOWN_MAC”, the STA will continue the 4-way HS procedure. If the status information indicates “RESEND_ID”, the STA will resend the ID. Further, the STA may send the previously assigned ID or MAC address or parameter(s) in 4-way HS Msg4, at (9). Also, the STA may assign another ID or MAC address or parameter(s) to the STA in 4-way HS Msg4. Then the STA and AP complete the 4-way HS and might start the data connection, at (10).

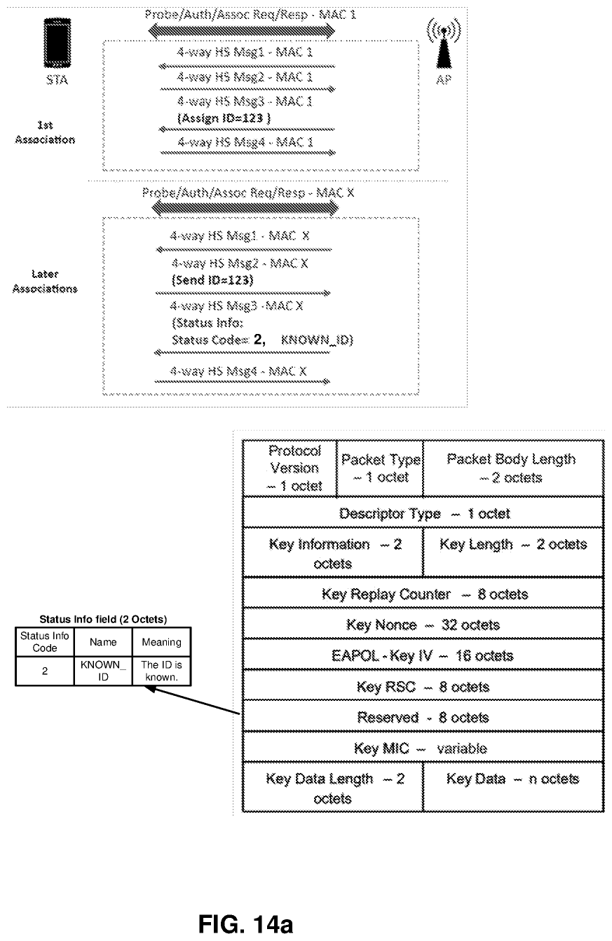

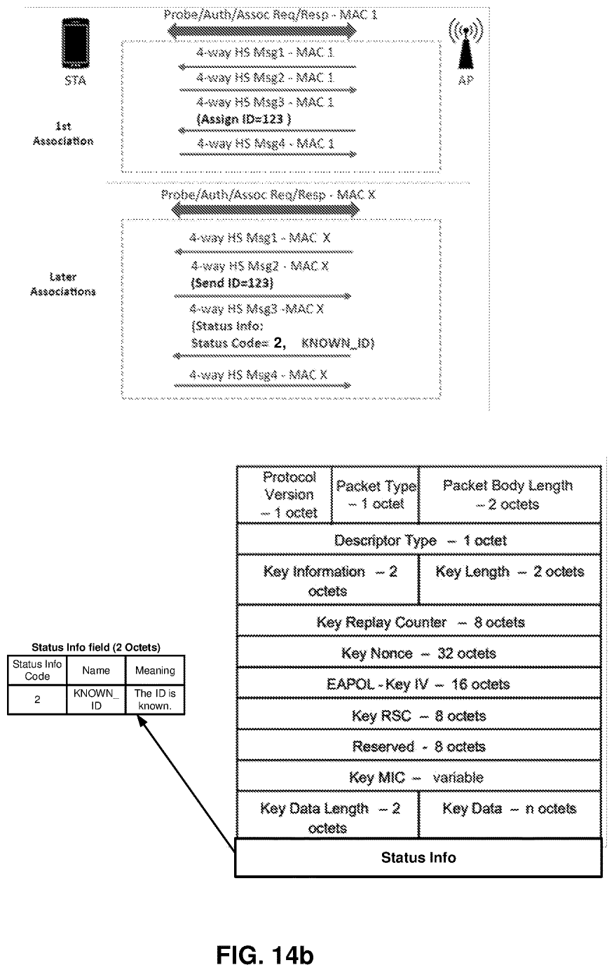

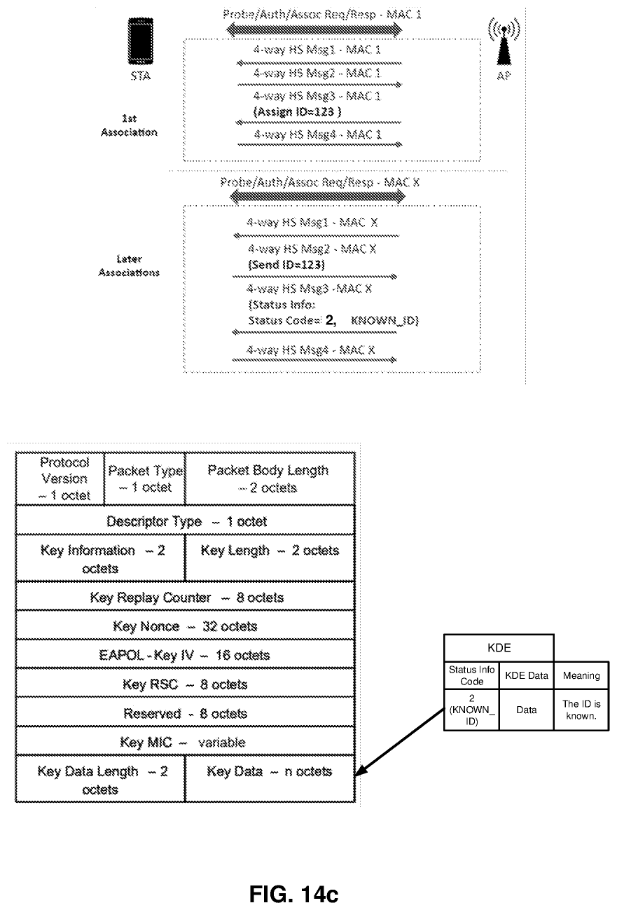

FIGS. 14a, 14b and 14c shows three cases illustrating how to use the status information in the 4-way handshake message according to some embodiments of the present disclosure. In these three cases, the first wireless device is the authenticator, e.g. the AP, and the second wireless device is the supplicant, e.g. the STA. The frame format of the 4-way handshake message used for status feedback has been shown in FIG. 8a, 8b or 8c and described above. Assume the following scenario:
The STA and AP use network initiated identification, where the AP generates and assigns the ID to the STA;
The AP assigns ID=123 to the STA in 4-way HS Msg3 in the first association;
The STA sends the previously assigned ID=123 in 4-way HS Msg2 in a later association; and
The AP sends the status information to the STA in 4-way HS Msg3. As an example, AP sends “status info code=2, KNOWN_ID”.

As shown in FIG. 14a, the status information is carried in the Reserved field. In this case, a “Status Info” field is defined in the Reserved field and includes 2 octets. In this scenario, the Status Info Code is 2, meaning that the ID is known to the AP.

As shown in FIG. 14b, the status information is carried in a new field, e.g. “Status Info” field in the 4-way handshake message. The new “Status Info” field may include 2 octets. In this scenario, the Status Info Code is 2, meaning that the ID is known to the AP.

As shown in FIG. 14c, the status information is carried in the Key Data field, as a part of 4-way HS Key Data (KDE). The KDE is shown in FIG. 14c. In this scenario, the Status Info Code is 2, meaning that the ID is known to the AP.

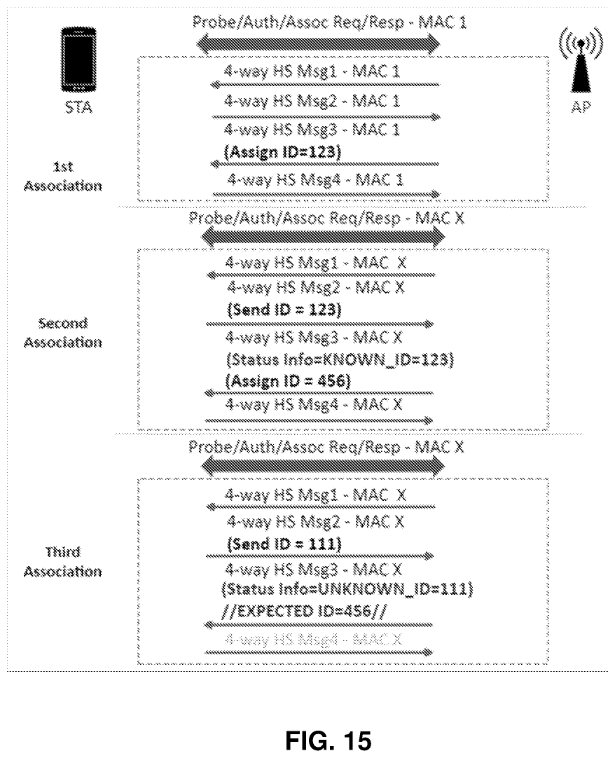

FIG. 15 illustrates an exemplary scenario in which some embodiments of the present disclosure can be implemented. In this exemplary scenario, the STA as the supplicant and the AP as the authenticator use network initiated identification, where the AP generates and assigns the ID to the STA.

As shown in FIG. 15, in a first association, the AP assigns ID=123 to the STA in 4-way HS Msg3. In a second association, the STA sends the previously assigned (from the first association) ID=123 in 4-way HS Msg2 to the AP. The AP recognizes ID=123, and thus sends “Status Info Code =2, KNOWN_ID” to the STA in 4-way HS Msg3. Since the identification for the STA is successful, the AP moves forward and assigns another ID=456 to the STA in 4-way HS Msg3.

In a third association, the STA sends ID=111 in 4-way HS Msg2. The AP does not recognize ID=111, and thus sends “Status Info Code=5, UNKNOWN_ID” to the STA in 4-way HS Msg3. Since the identification for the STA failed, the 4-way HS procedure stops.

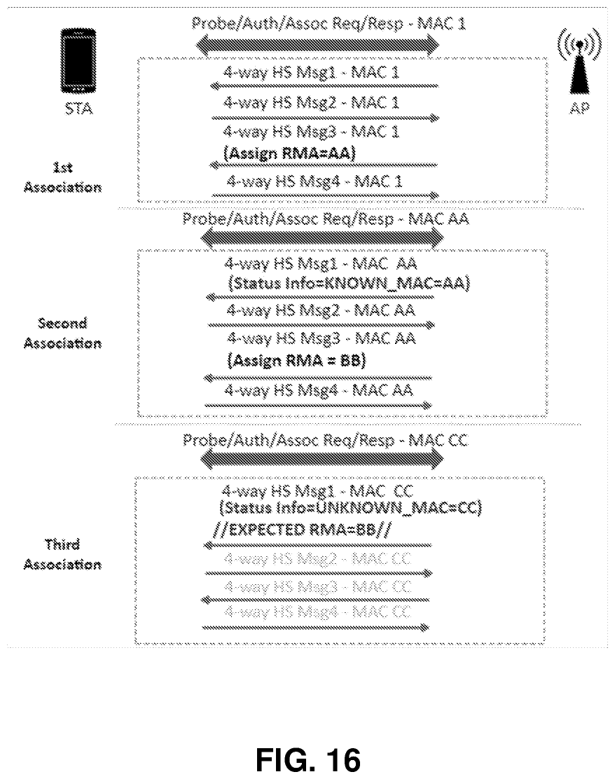

FIG. 16 illustrates an exemplary scenario in which some embodiments of the present disclosure can be implemented. In this exemplary scenario, the STA as the supplicant and the AP as the authenticator use network initiated identification, where the AP generates and assigns the random MAC (RMA) to the STA.

As shown in FIG. 16, in a first association, the AP assigns RMA=AA to the STA in 4-way HS Msg3. In a second association, the STA sends RMA=AA in a probe/authentication/association request to the AP. The AP recognizes RMA=AA, and thus sends “Status Info Code=3, KNOWN_MAC” to the STA in 4-way HS Msg1. Since the identification for the STA is successful, the AP moves forward and assigns another RMA=BB to the STA in 4-way HS Msg3.

In a third association, the STA sends RMA=CC in a probe/authentication/association request to the AP. The AP does not recognize RMA=CC, and thus sends “Status Info Code=6, UNKNOWN_MAC” to the STA in 4-way HS Msg1. Since the identification for the STA failed, the 4-way HS procedure stops.

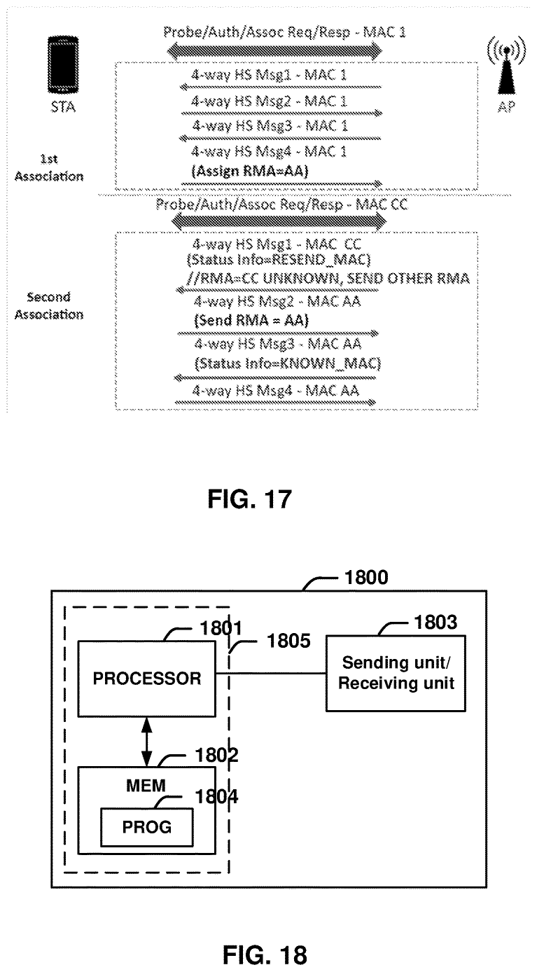

FIG. 17 illustrates an exemplary scenario in which some embodiments of the present disclosure can be implemented. In this exemplary scenario, the STA as the supplicant and the AP as the authenticator use STA initiated identification, where the STA generates and assigns RMA to itself and notifies the AP.

As shown in FIG. 17, in a first association, the STA assigns RMA=AA to itself and notifies the AP in 4-way HS Msg4. In a second association, the STA sends RMA=CC in a probe/authentication/association request to the AP. The AP does not recognize RMA=CC, but it expects another RMA, possibly RMA=AA. Thus, the AP sends “Status Info Code=12, RESEND_MAC” to the STA in 4-way HS Msg1. Then the STA sends RMA=AA to the AP in 4-way HS Msg2. The AP recognizes RMA=AA, and thus sends “Status Info Code=3, KNOWN_MAC” to the STA in 4-way HS Msg3. Since the identification for the STA is successful, the 4-way HS procedure is completed.

Although the exemplary embodiments have been described in the case that the status information is transmitted/received in the 4-way handshake Msg1 and/or 4-way handshake Msg3, those skilled in the art will appreciate that the status information can be transmitted/received in the 4-way handshake Msg2 and/or 4-way handshake Msg4.

Now reference is made to FIG. 18 illustrating a simplified block diagram of an apparatus 1800 that may be embodied as the first wireless device or the second wireless device. The apparatus 1800 may comprise at least one processor 1801, such as a data processor (DP) and at least one memory (MEM) 1802 coupled to the at least one processor 1801. The apparatus 1800 may further comprise a sending unit and a receiving unit 1803 coupled to the one or more processors 1801.

The processors 1801 may be of any type suitable to the local technical environment, and may include one or more of the following: general purpose computers, special purpose computers, microprocessors, digital signal processors (DSPs) and processors based on multicore processor architecture, as non-limiting examples.

The MEM(s) 1802 may be of any type suitable to the local technical environment and may be implemented using any suitable data storage technology, such as semiconductor-based memory devices, magnetic memory devices and systems, optical memory devices and systems, fixed memory and removable memory, as non-limiting examples.

The MEM 1802 stores a program (PROG) 1804. The PROG 1804 may include instructions that, when executed on the associated processor 1801, enable the apparatus 1800 to operate in accordance with the embodiments of the present disclosure, for example to perform one of the methods 1000 and 1100 as shown in FIG. 10 and FIG. 11. A combination of the at least one processor 1801 and the at least one MEM 1802 may form processing circuitry or means 1805 adapted to implement various embodiments of the present disclosure.

Various embodiments of the present disclosure may be implemented by a computer program executable by one or more of the processors 1801, software, firmware, hardware or in a combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosures may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosures may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium, for example, non-transitory computer readable medium, such as a hard disk, optical disk, removable storage media, solid state memory, RAM, etc. As will be appreciated by one of skills in the art, the function of the program modules may be combined or distributed as desired in various embodiments. In addition, the function may be embodied in whole or in part in firmware or hardware equivalents such as integrated circuits, field programmable gate arrays (FPGA), and the like.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-57. (canceled)

58. A first wireless device, comprising:
at least one processor; and
at least one memory storing instructions that, when executed by the at least one processor, cause the first wireless device at least to:
receive a first message from a second wireless device, the first message comprising identification information of the second wireless device;
determine status information at least based on the identification information, the status information indicating a feedback to the first message; and
transmit, to the second wireless device, the status information in a 4-way handshake message in a 4-way handshake procedure between the first wireless device and the second wireless device.

59. The first wireless device according to claim 58, wherein the identification information comprises at least one of the following: an identifier, a medium access control (MAC) address, or one or more parameters related to generation of the identifier or the MAC address.

60. The first wireless device according to claim 58, wherein the first message is one of: a management frame in an attach procedure between the first wireless device and the second wireless device, or the 4-way handshake message in the 4-way handshake procedure.

61. The first wireless device according to claim 58, wherein to determine the status information, the first wireless device is caused to at least one of:
compare the received identification information with obtained identification information of the second wireless device;
determine whether the received identification information is out of date; or
determine whether the received identification information is duplicated.

62. The first wireless device according to claim 58, wherein the status information indicates at least one of the following:
success of an operation related to the first message;
failure of the operation related to the first message;
the received identification information is known to the first wireless device;
the received identification information is unknown to the first wireless device;
the received identification information is duplicated; or
the identification information of the second wireless device needs to be re-sent.

63. The first wireless device according to claim 58, wherein the first wireless device is an authenticator in a wireless network, and wherein the second wireless device is a supplicant in the wireless network.

64. The first wireless device according to claim 63, wherein the first message is a management frame in an attach procedure between the first wireless device and the second wireless device, and wherein the 4-way handshake message in which the status information is transmitted is a 4-way handshake message 1 in the 4-way handshake procedure.

65. The first wireless device according to claim 63, wherein the first message is a 4-way handshake message 2 in the 4-way handshake procedure, and wherein the 4-way handshake message in which the status information is transmitted is a 4-way handshake message 3 in the 4-way handshake procedure.

66. A second wireless device, comprising:
at least one processor; and
at least one memory storing instructions that, when executed by the at least one processor, cause the second wireless device at least to:
transmit a first message to a first wireless device, the first message comprising identification information of the second wireless device;
receive, from the first wireless device, status information in a 4-way handshake message in a 4-way handshake procedure between the first wireless device and the second wireless device, the status information indicating a feedback to the first message; and
determine an operation based on the status information.

67. The second wireless device according to claim 66, wherein the identification information comprises at least one of the following: an identifier, a medium access control (MAC) address, or one or more parameters related to generation of the identifier or the MAC address.

68. The second wireless device according to claim 66, wherein the first message is one of: a management frame in an attach procedure between the first wireless device and the second wireless device, or the 4-way handshake message in the 4-way handshake procedure.

69. The second wireless device according to claim 66, wherein the status information indicates at least one of the following:
success of the operation related to the first message;
failure of the operation related to the first message;
the transmitted identification information is known to the first wireless device;
the transmitted identification information is unknown to the first wireless device;
the transmitted identification information is duplicated; or
the identification information of the second wireless device needs to be re-sent.

70. The second wireless device according to claim 66, wherein one of the following applies:
the status information is carried in a reserved field of the 4-way handshake message;
the status information is carried in a new field of the 4-way handshake message; or
the status information is carried in a key data field of the 4-way handshake message.

71. The second wireless device according to claim 66, wherein the least one memory storing the instructions that, when executed by the at least one processor, further cause the second wireless device to:
continue the 4-way handshake procedure;
resend the identification information of the second wireless device;
send a different identification information of the second wireless device;
not send the identification information of the second wireless device; or
stop the 4-way handshake procedure.

72. The second wireless device according to claim 66, wherein the status information is received in at least one of a 4-way handshake message 1, a 4-way handshake message 2, a 4-way handshake message 3, and a 4-way handshake message 4 in the 4-way handshake procedure.

73. The second wireless device according to claim 66, wherein the first wireless device is an authenticator in a wireless network, and wherein the second wireless device is a supplicant in the wireless network.

74. The second wireless device according to claim 73, wherein the first message is a management frame in an attach procedure between the first wireless device and the second wireless device, and wherein the 4-way handshake message in which the status information is received is a 4-way handshake message 1 in the 4-way handshake procedure.

75. The second wireless device according to claim 73, wherein the first message is a 4-way handshake message 2 in the 4-way handshake procedure, and wherein the 4-way handshake message in which the status information is received is a 4-way handshake message 3 in the 4-way handshake procedure.

76. The second wireless device according to claim 66, wherein the first wireless device is a supplicant in a wireless network, and wherein the second wireless device is an authenticator in the wireless network.

77. A method performed by a second wireless device, the method comprising:
transmitting a first message to a first wireless device, the first message comprising identification information of the second wireless device;
receiving, from the first wireless device, status information in a 4-way handshake message in a 4-way handshake procedure between the first wireless device and the second wireless device, the status information indicating a feedback to the first message; and
determining an operation based on the status information.
